(19) United States
(12) Patent Application Publication
(10) Pub. No.: US 2009/0316237 A1
(43) Pub. Date: Dec. 24, 2009

(54) HOLOGRAM RECORDER

(75) Inventors: Kazushi Uno, Kawasaki (JP); Yasumasa Iwamura, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/548,017

(22) Filed: Aug. 26, 2009

Related U.S. Application Data
(63) Continuation of application No. PCT/JP2007/055498, filed on Mar. 19, 2007.

(51) Int. Cl. G03H 1/04

(52) U.S. Cl. 359/1

(57) ABSTRACT

A hologram recorder (A) which records holograms by causing a recording beam (P) and a reference beam (S) to interfere with each other in a hologram recording media (B), includes an incident-side and an emitting-side lenses (3a, 3b) provided as a compound lens disposed in a laser beam path between a light source (1) and a beam separator (7); and an aperture stop (5) provided to limit a light flux diameter between the incident-side and emitting-side lenses (3a, 3b). The aperture stop (5) is disposed at a position biased toward the incident-side lens (3a) as viewed from an incident-side focal position of the emitting-side lens (3b).

This application is a continuing application, filed under 35 U.S.C. §111(a), of International Application PCT/JP2007/055498, filed Mar. 19, 2007.

### TECHNICAL FIELD

The present invention relates to a hologram recorder which records holograms by causing a recording beam and a reference beam to interfere with each other in a hologram recording medium.

### BACKGROUND ART

An example of a conventional hologram recorder is disclosed in Patent Document 1. The hologram recorder is configured to record holograms by: splitting laser light emitted from a light source into a recording beam and a reference beam with the use of a beam splitter; modulating the recording beam based on information to be recorded with the use of a spatial light modulator; and causing the recording beam and the reference beam to interfere with each other in a hologram recording medium. A beam converter (beam shape arrangement element) is disposed between the light source and the beam splitter in order to uniformize the distribution of light intensity of the laser light. In the hologram recorder provided with such a beam converter, the laser light is converted by the beam converter so that its light intensity is shaped into uniform distribution from Gaussian distribution, and thus the recording beam emitted from the spatial light modulator is also uniformized. Accordingly, it is possible to record a hologram by uniform interference fringe patterns of dark and bright, which prevents a readout error in reproducing the hologram.

Patent Document 1: Japanese Lain-open Patent Publication No. 2006-145676

In the conventional hologram recorder described above, substantially no special concern is given to the flux diameter of the reference beam, and unnecessary scattering or diffraction of light may occur unless the reference beam is properly narrowed. To prevent these inconveniences, for example, an aperture stop may be arranged on the optical path of the reference beam. However, if the position of the aperture stop is not appropriate, the dispersion or diffraction of light may not be prevented sufficiently, and an optically clear hologram may not be recorded.

### DISCLOSURE OF THE INVENTION

The present invention has been proposed under the above-described circumstances. It is, therefore, an object of the present invention to provide a hologram recorder which is capable of preventing unnecessary beam scattering or diffraction, thereby recording an optically clear hologram.

To solve the problem described above, the present invention takes the following technical measures.

According to the present invention, there is provided a hologram recorder for recording a hologram by splitting a laser light emitted from a light source with the use of a beam separator into a recording beam and a reference beam, modulating the recording beam in accordance with information to be recorded, and causing the recording beam and the reference beam to interfere with each other at a hologram recording medium. The hologram recorder includes: an incident-side lens and an emitting-side lens provided as a compound lens disposed in at least one of a path between the light source and the beam separator along which the laser light travels and a path between the beam separator and the hologram recording medium along which the reference beam travels; and an aperture stop for limiting a light flux diameter between the incident-side and emitting-side lenses. The aperture stop is disposed at a position offset toward the incident-side lens from an incident-side focal position of the emitting-side lens.

Preferably, the incident-side and emitting-side lenses are provided as a beam expander between the light source and the beam separator.

Preferably, the incident-side and emitting-side lenses are provided as a beam converter for uniformizing a light intensity distribution between the light source and the beam separator.

Preferably, a spatial filter is disposed at the incident-side focal position of the emitting-side lens.

Preferably, the incident-side and emitting-side lenses are provided as a beam demagnifying optical system between the beam separator and the hologram recording medium.

Preferably, a relation expressed as d≈L×f/(L−f) is established, where L represents a distance from the aperture stop to a principal point of the emitting-side lens at a side of light source, f represents an incident-side focal length of the emitting-side lens, and d represents an optical path length from the emitting-side lens to the hologram recording medium.

### BRIEF DESCRIPTION OF THE DRAWINGS

FIG. 1 is an overall configuration diagram of an embodiment of a hologram recorder according to the present invention.

FIG. 2 is an overall configuration diagram which illustrates a state of reproducing operation of the hologram recorder illustrated in FIG. 1.

FIG. 3 is a conceptual diagram for describing a primary portion of the hologram recorder illustrated in FIG. 1.

FIG. 4 is an overall configuration diagram which illustrates another embodiment of a hologram recorder according to the present invention.

FIG. 5 is an overall perspective view which illustrates another embodiment of a hologram recorder according to the present invention.

FIG. 6 is a conceptual diagram for describing a primary portion of the hologram recorder illustrated in FIG. 5.

### BEST MODE FOR CARRYING OUT THE INVENTION

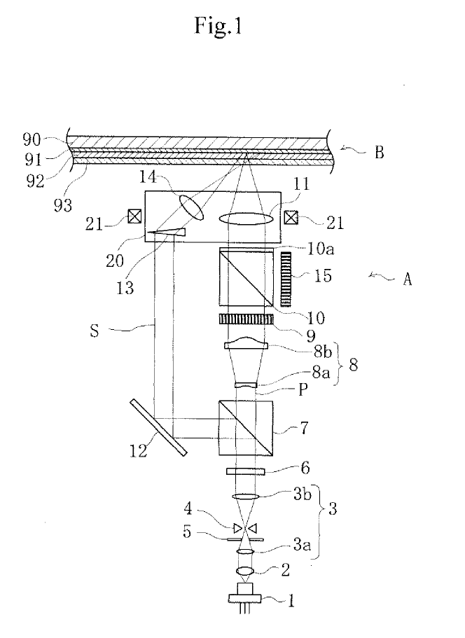

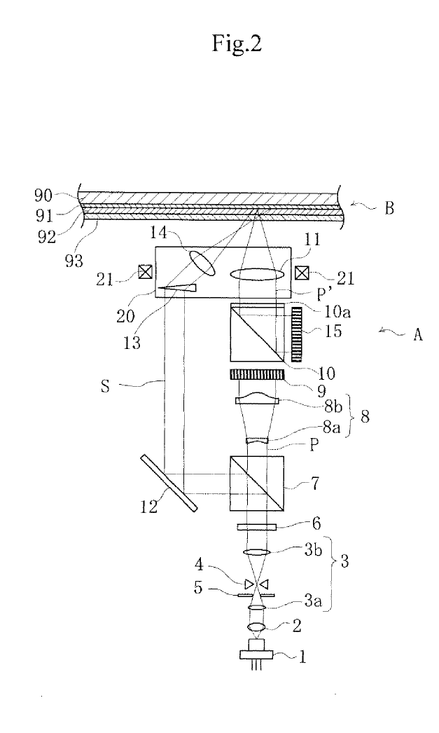

Preferred embodiments of the present invention will be described below with reference to the drawings. FIGS. 1 to 3 illustrate an embodiment of a hologram recorder according to the present invention. FIG. 1 illustrates the operating state in recording whereas FIG. 2 illustrates the operating state in reproducing.

As illustrated in FIGS. 1 and 2, a hologram recorder A includes a light source 1, a collimator lens 2, a the beam expander 3, a spatial filter 4, an aperture stop 5, a phase plate 6, a polarizing beam splitter 7 as beam separation means, a beam converter 8, a spatial light modulator 9, a recording/reproducing polarizing beam splitter 10, an objective lens 11 for both the recording and reproducing beams, a reflector plate 12, a prism 13, a reference beam objective lens 14, an imaging device 15, and a hologram recording medium B. The objective lenses 11, 14 and the prism 13 are incorporated in a head unit 20. The position of the head unit 20 is adjusted in a thickness direction of the hologram recording medium B by a driver 21 such as an electromagnetic coil. The hologram recording medium B has a laminated structure including a substrate 90, a reflection film 91, a recording layer 92 and a protective film 93, and emits a reproduction beam P′ as a reflected beam in reproducing.

The light source 1 is provided by e.g. a semiconductor laser device and emits a laser light which has a relatively narrow band and a high coherency. The laser light immediately after leaving the light source 1 has a light intensity distribution of Gaussian distribution, and impinges on the collimator lens 2 in the form of diverging light. The collimator lens 2 converts the diverging laser light into a parallel light.

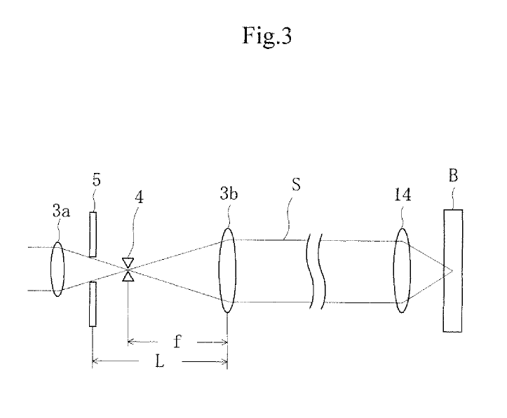

The beam expander 3 is provided by a compound lens constituted of an incident-side lens 3a and an emitting-side lens 3b, and is disposed between the collimator lens 2 and the phase plate 6. The beam expander 3 increases the light flux diameter of the laser light emitted from the collimator lens 2. As illustrated in FIG. 3, the emitting-side lens 3b has an focal length f at the incident side from the principal point at the side of the light source. The emitting-side focal position of the incident-side lens 3a generally matches the incident-side focal position of the emitting-side lens 3b. The laser light emitted from the emitting-side lens 3b impinges on the phase plate 6.

The spatial filter 4 is provided between the incident-side and emitting-side lenses 3a, 3b, and disposed substantially at the incident-side focal position of the emitting-side lens 3b. The spatial filter 4 is provided with a pinhole allowing the laser beam to pass. The pinhole eliminates optical noise such as high-order diffraction light and aberration.

The aperture stop 5 is provided between the incident-side and the emitting-side lenses 3a, 3b for limiting the light flux diameter of the laser light by its aperture. Specifically, as illustrated in FIG. 3, the aperture stop 5 is disposed on the side of the incident lens 3a, that is, offset toward the incident lens 3a from the incident-side focal position of the emitting-side lens 3b. In other words, supposing the distance from the aperture stop 5 to the principal point of the emitting-side lens 3b at the side of the light source is L, the relation f<L is satisfied. Thus, even if diffraction of the laser light passing through the aperture occurs, the aperture stop 5 is disposed at a position which does not allow the diffraction to influence regions beyond the spatial filter 4.

The phase plate 6 is provided by e.g. a liquid crystal panel and changes the polarizing direction of the laser light along a twist of the liquid crystal molecules. When the laser light travels from the emitting-side lens 3b to the phase plate 6, the state of polarization of the laser light changes due to the phase difference caused by the phase plate 6, whereby an apparent ratio between the amount of light transmitted in the polarizing beam splitter 7 and the amount of light reflected at the polarizing beam splitter changes.

The polarizing beam splitter 7 serving as beam separation means splits the laser light emitted from the phase plate 6 into a recording beam P and a reference beam S whose polarizing directions are perpendicular to each other. For example, the recording beam P of p-polarization passes through the incident plane of the polarizing beam splitter 7 and then travels to travel to the beam converter 8, whereas the reference beam S of s-polarization is reflected on the incident plane of the polarizing beam splitter 7. The reflected reference beam S travels to the reflector plate 12, the prism 13 and the reference beam objective lens 14 in this order, and in the recording operation, illuminates the hologram recording medium B so as to interfere with the recording beam P.

The beam converter 8 is provided by a compound lens constituted of an incident-side lens 8a and an emitting-side lens 8b, and is disposed between the polarizing beam splitter 7 and the spatial light modulator 9. The recording beam P having a light intensity distribution of Gaussian distribution impinges on the incident-side lens 8a, and the recording beam P having a uniformized light intensity distribution is emitted from the emitting-side lens 8b to travel to the spatial light modulator 9.

The spatial light modulator 9 is provided by e.g. a liquid crystal display device and performs pixel modulation of the recording beam P based on information to be recorded. The recording beam P emitted from the spatial light modulator 9 travels to the recording/reproducing polarizing beam splitter 10. The polarizing beam splitter 10 is provided with a rotatable half-wavelength plate 10a on its surface opposed to the objective lens 11. The recording beam P passes through the polarizing beam splitter 10 to reach the half-wavelength plate 10a. The half-wavelength plate 10a guides the incident recording beam P to the objective lens 11 by taking a predetermined rotating attitude. In the reproducing operation, the half-wavelength plate 10a changes its rotating attitude to another predetermined rotating attitude different from the one for the recording operation. Thus, in the reproducing operation, the reproduction beam P′ returning from the hologram recording medium B through the objective lens 11 travels through the half-wavelength plate 10a to the polarizing beam splitter 10 with its polarizing direction changed by 90 degrees from that of the recording beam P. Then, the reproduction beam P′ is reflected by the polarizing beam splitter 10 to travel to the imaging device 15.

The objective lens 14 for the reference beam is disposed in the manner such that its optical axis intersects with that of the objective lens 11 for the recording beam and the reproducing beam at a predetermined angle. At the time of recording, the reference beam S is guided so as to pass through the objective lens 14 and then overlap the recording beam P in the recording layer 92 of the hologram recording medium B. Thus, the recording beam P and the reference beam S interfere with each other and thereby a hologram is recorded in the recording layer 92. At the time of reproducing, the reference beam S illuminates a predetermined area in the recording layer 92 where a recorded hologram is stored. As a result a reproduction beam P′ corresponding to the recorded hologram is emitted from the predetermined area of the recording layer 92, and this reproduction beam P′ is received by the imaging device 15. When the hologram recording medium B is illuminated, the recording beam P has a uniform light intensity distribution whereas the reference beam S has a light intensity distribution characterized as Gaussian distribution.

The imaging device 15 is provided by e.g. a CCD or a CMOS light receiving sensor and converts the reproduction beam P′ into digital signals to read out information recorded in the form of hologram.

Next, the optical operation of the hologram recorder A will be described.

In recording, as illustrated in FIG. 1, a laser light emitted from the light source 1 travels through the collimator lens 2, the incident-side lens 3a, the aperture stop 5, the spatial filter 4, the emitting-side lens 3b and the phase plate 6 sequentially, and then impinges on the polarizing beam splitter 7.

In this process, since the light flux diameter of the laser light is reduced by the aperture stop 5 between the beam incident-side and the emitting-side lenses 3a, 3b, scattering of the light does not occur. On the other hand, since the laser light passes through the aperture of the aperture stop 5, the laser light diffracts around the aperture, and the diffraction results in appearance of diffraction light. The diffraction light is removed efficiently by causing the laser light to pass through the pinhole in the spatial filter 4, which is smaller than the aperture of the aperture stop 5.

The laser light from which optical noise has been removed in this way is split by the polarizing beam splitter 7 into a recording beam P and a reference beam S. The light intensity distribution of the recording beam P is uniformized by the beam converter 8. Then, the recording beam P is modulated into light of the pixel pattern corresponding to the information to be recorded by the spatial light modulator 9. After that, the recording beam P passes through the objective lens 11 to impinge on a predetermined area of the hologram recording medium B. Therefore, the pixel pattern with a uniform intensity over the entire pattern is formed in the spatial light modulator 9.

On the other hand, the reference beam S travels through the objective lens 14 having the intensity distribution of Gaussian distribution and illuminates the predetermined area of the hologram recording medium B so as to overlap the recording beam P. Thus, a hologram is recorded in the predetermined area of the hologram recording medium B by interference between the recording beam P and the reference beam S. In this process, since the position of the aperture stop 5 is almost conjugate with the position of the area illuminated with the reference beam S on the hologram recording medium B, the spatial filter 4 and the aperture stop 5 sufficiently remove optical noise from the recording beam P and the reference beam S, and the light intensity distribution of each of the beams becomes a desired light intensity distribution. Therefore, even if the recording beam P and the reference beam S travel along relatively long optical paths to reach the hologram recording medium B, large amount of optical noise is not generated, and a hologram constituted of an interference fringe pattern having a uniform brightness is recorded.

In reproducing, as illustrated in FIG. 2, the laser light emitted from the light source 1 impinges on the polarizing beam splitter 7 similarly to the case of recording, and is split into a recording beam P and a reference beam S. Then, the recording beam P is directed to the spatial light modulator 9, and the spatial light modulator 9 is kept in the off-state during the reproduction process and thereby does not allow the light to pass. Thus, the hologram recording medium B is illuminated only by the reference beam S. The reference beam S illuminates a predetermined area of the hologram recording medium B, and the reproduction beam P is generated by interference between a recorded hologram and the reference beam S. The reproduction beam P′ travels through the objective lens 11 and the polarizing beam splitter 10 and is received by the imaging device 15. As a result, information recorded in the form of hologram is reproduced.

Also in reproduction, the reference beam S propagates with a light intensity distribution characterized as Gaussian distribution. Since, in particular, the position of the aperture stop 5 is almost conjugate with the position of the area illuminated by the reference beam S on the hologram recording medium B, optical noise is sufficiently removed by the spatial filter 4 and the aperture stop 5. Thus, the reference beam S reaches the hologram recording medium B without being influenced by diffraction and so on. In this way, the imaging device 15 can recognize the hologram as having a uniform brightness, a reading error caused by inconsistency in brightness can be avoided.

Hence, by using the hologram recorder A according to the present embodiment, optical noise such as unnecessary dispersion, diffraction and so on are removed efficiently from the laser light before the laser light is split into the recording beam P and the reference beam S. Thus, optically clear holograms can be recorded in the hologram recording medium B, and therefore reading errors is prevented at the time of reproducing.

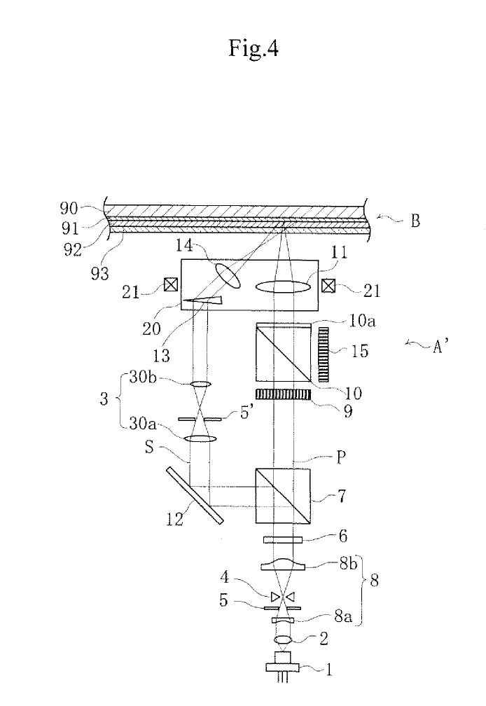

FIGS. 4 to 6 illustrate other embodiments of a hologram recorder according to the present invention. In these figures, the elements which are identical or similar to those of the foregoing embodiment are designated by the same reference signs as those used for the foregoing embodiment, and the description is omitted.

A hologram recorder A′ illustrated in FIG. 4 includes a beam converter 8 disposed between a collimator lens 2 and a phase plate 6, and a demagnifying lens 30 as a beam narrowing optical system disposed between a reflector plate 12 and a prism 13.

The beam converter 8 uniformizes the beam intensity distribution of the laser light and directs the laser light having uniformized light intensity distribution to the phase plate 6. The spatial filter 4 is disposed between the incident-side and emitting-side lenses 8a, 8b of the beam converter 8, and substantially at the incident-side focal position of the emitting-side lens 8b. The aperture stop 5 is disposed between the incident-side and emitting-side lenses 8a, 8b, and specifically, at the same position as illustrated in FIG. 3. In other words, the aperture stop 5 is disposed closer to the entrance-side lens 8a than the incident-side focal position of the emitting-side lens 8b. Therefore, even if diffraction of the laser light passing through the aperture of the aperture stop 5 occurs, influences of such diffraction become minimal on the hologram recording medium B in recording and reproducing.

The demagnifying lens 30 is provided by a compound lens constituted of an incident-side lens 30a and an emitting-side lens 30b. The demagnifying lens 30 decreases the light flux diameter of the reference beam P. An aperture stop 5′ is provided between the incident-side and emitting-side lenses 30a, 30b. The aperture stop 5′ limits the light flux diameter of the reference beam P with its aperture. The aperture stop 5′ is also disposed closer to the incident-side lens 30a than the incident-side focal position of the emitting-side lens 30b. With this arrangement, optical noise such as unnecessary dispersion is removed from the reference beam S.

According to the arrangement described above, the light intensity distribution of the laser beam is uniformized by the beam converter 8, and optical noise is sufficiently removed by the spatial filter 4 and the aperture stop 5. Further, optical noise is removed from the reference beam S by the aperture stop 5′ disposed between the two demagnifying lenses 30.

Hence, the hologram recorder A′ is also capable of removing optical noise efficiently from the laser light and the reference beam, and therefore optically clear holograms are recorded in the hologram recording medium B, which prevents reading errors at the time of reproducing.

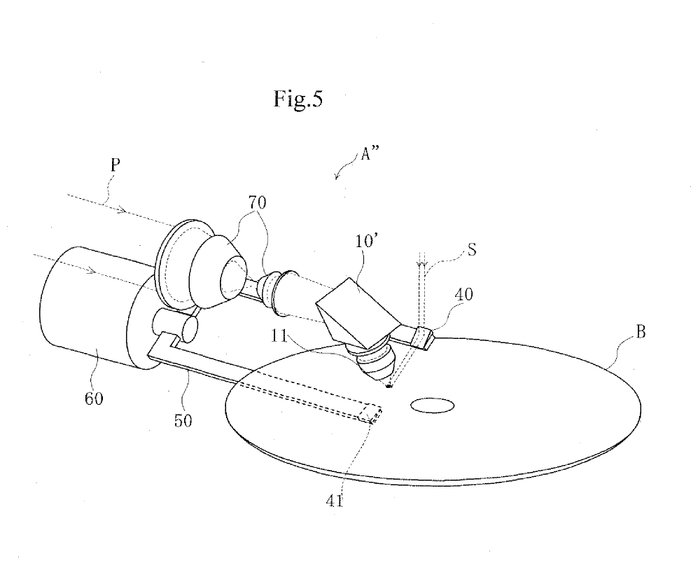

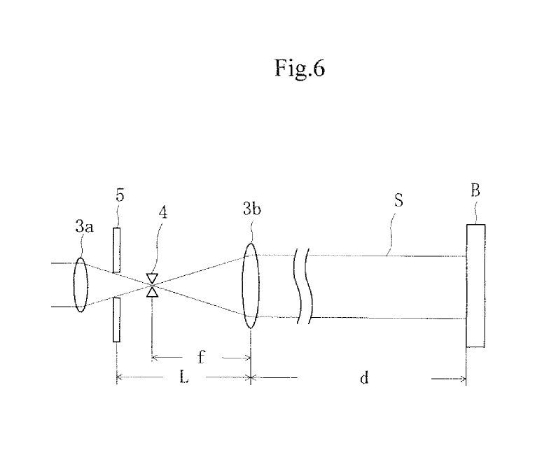

The hologram recorder A″ illustrated in FIGS. 5 and 6 illuminates the hologram recording medium B with a recording beam P and a reference beam S, but the illuminating mechanism is different from that of the foregoing embodiments. On the other hand, the unillustrated optical system is similar to that of the foregoing embodiments. In the hologram recorder A″, mirrors 40, 41 are provided at the respective tips of an arm 50 for guiding the reference beam S, and the arm 50 is caused to pivot by a driving motor 60.

The recording beam P from an unillustrated spatial light modulator is directed to an objective lens 11 via relay lenses 70 and a half mirror 10′, and then passing through the objective lens 11, the beam illuminates, at a fixed incident angle, a predetermined area of the hologram recording medium B. In recording, a reference beam S illuminates the predetermined area of the hologram recording medium B via the upper mirror 40 so as to overlap the recording beam P. In this process, the arm 50 is caused to pivot for varying the incident angle of the reference beam S. Thus, the intersecting angle of the recording beam P and the reference beam S is changed, and each time the angle is varied, a hologram of a different pattern is recorded to establish multiple recording.

The reference beam P in reproducing is conjugate to the reference beam in recording. In reproducing, the reference beam P illuminates a predetermined area of the hologram recording medium B through the lower mirror 41. Also in reproducing, the arm 50 pivots to vary the incident angle of the reference beam S. Thus, at the predetermined area of the hologram recording medium B, each time the incident angle of the reference beam P becomes equal to the incident angle of that in recording, the recorded hologram generates diffracted light, and this diffracted light is directed to an unillustrated imaging device as the reproduction light. As a result, information recorded in the form of hologram is reproduced.

As illustrated in FIG. 6, the hologram recorder A″ is also provided with an aperture stop 5 between the incident and emitting-side lenses 3a, 3b so that the beam flux diameter of the laser light is limited with the aperture. Specifically, the aperture stop 5 is disposed closer to the incident-side lens 3a than the incident-side focal position of the emitting-side lens 3b. In other words, supposing that the distance from the aperture stop 5 to the principal point of the exit-side lens 3b at the side of the light source is L, the inequality f<L is satisfied. Therefore, even if there is diffraction of the laser beam passing through the aperture, the aperture stop 5 prevents the influence of such diffraction from propagating farther than the spatial filter 4. Further, supposing that the distance of the optical path of the reference beam S from the principal point of the exit-side lens 3b at the side of the light source to the hologram recording medium B is d, the relation d≈L×f/(L−f). This is obtained by application of the lens equation to the emitting-side lens 3b. Here, the optical path length (not illustrated) of the recording beam P is generally equal to the optical path length d of the reference beam S.

By using the hologram recorder A″ which such structure, multiple recording of holograms can be performed, and each of the holograms can be recorded with optical clarity.

The present invention is not limited to the embodiments described above.

The laser beam may be split into the recording beam and the reference beam by a simple beam splitter which does not have polarizing characteristics. In this case, there is no need to provide a phase plate at the incident side of the beam splitter.

The aperture stop and the spatial filter may be disposed between the relay lenses as far as they are arranged to form the configuration illustrated in FIG. 3. Further, the aperture stop and the spatial filter need to be disposed between each of the lenses, and may be provided at two or more locations.

1. A hologram recorder for recording a hologram by splitting a laser light emitted from a light source with a beam separator into a recording beam and a reference beam, modulating the recording beam in accordance with information to be recorded, and causing the recording beam and the reference beam to interfere with each other at a hologram recording medium, the hologram recorder comprising:
an incident-side lens and an emitting-side lens provided as a compound lens disposed in at least one of a path between the light source and the beam separator along which the laser light travels and a path between the beam separator and the hologram recording medium along which the reference beam travels; and
an aperture stop for limiting a light flux diameter between the incident-side and emitting-side lenses;
wherein the aperture stop is offset toward the incident-side lens from an incident-side focal position of the emitting-side lens.

2. The hologram recorder according to claim 1, wherein the incident-side and emitting-side lenses are provided as a beam expander between the light source and the beam separator.

3. The hologram recorder according to claim 1, wherein the incident-side and emitting-side lenses are provided as a beam converter for uniformizing a light intensity distribution between the light source and the beam separator.

4. The hologram recorder according to claim 2 or 3, wherein a spatial filter is disposed at the incident-side focal position of the emitting-side lens.

5. The hologram recorder according to claim 1, wherein the incident-side and emitting-side lenses are provided as a beam demagnifying optical system between the beam separator and the hologram recording medium.

6. The hologram recorder according to any one of claims 1, 2, 3 or 5, wherein a relationship expressed as d≈L×f/(L−f) is established, where L represents a distance from the aperture stop to a principal point of the emitting-side lens at a side of light source, f represents an incident-side focal length of the emitting-side lens, and d represents an optical path length from the emitting-side lens to the hologram recording medium.
